(19) United States
(12) Patent Application Publication
(10) Pub. No.: US 2021/0058702 A1
(43) Pub. Date: Feb. 25, 2021

(54) ONE-DIMENSIONAL ARRAY MICROPHONE WITH IMPROVED DIRECTIVITY

(71) Applicant: Shure Acquisition Holdings, Inc., Niles, IL (US)

(72) Inventors: Brent Robert Shumard, Mount Prospect, IL (US); Mark Gilbert, Palatine, IL (US); James Michael Pessin, Forest Park, IL (US); Emily Ann Wigley, Chicago, IL (US)

(21) Appl. No.: 17/000,295

(22) Filed: Aug. 22, 2020

Related U.S. Application Data
(60) Provisional application No. 62/891,088, filed on Aug. 23, 2019.

(51) Int. Cl. H04R 3/00; H04R 1/40; H04R 1/24; H04R 19/04

(52) U.S. Cl. CPC H04R 3/005; H04R 1/406; H04R 2201/003; H04R 19/04; H04R 2201/403; H04R 1/245

(57) ABSTRACT

Embodiments include an array microphone comprising a plurality of microphone sets arranged in a linear pattern relative to a first axis and configured to cover a plurality of frequency bands. Each microphone set comprises a first microphone arranged along the first axis and a second microphone arranged along a second axis orthogonal to the first microphone, wherein a distance between adjacent microphones along the first axis is selected from a first group consisting of whole number multiples of a first value, and within each element, a distance between the first and second microphones along the second axis is selected from a second group consisting of whole number multiples of a second value.

### CROSS-REFERENCE

This application claims priority to U.S. Provisional Application No. 62/891,088, filed on Aug. 23, 2019, the contents of which are incorporated herein in their entirety.

### TECHNICAL FIELD

This application generally relates to an array microphone. In particular, this application relates to a linear array microphone configured to provide improved frequency-dependent directivity.

### BACKGROUND

Conferencing environments, such as conference rooms, boardrooms, video conferencing applications, and the like, can involve the use of one or more microphones to capture sound from various audio sources active in the environment. Such audio sources may include in-room human speakers, for example. The captured sound may be disseminated to a local audience in the environment through loudspeakers, and/or to others remote from the environment (such as, e.g., via a telecast and/or webcast, telephony, etc.).

The types of microphones used and their placement in a particular conferencing environment may depend on the locations of the audio sources, physical space requirements, aesthetics, room layout, and/or other considerations. For example, in some environments, the microphones may be placed on a table or lectern near the audio sources. In other environments, the microphones may be mounted overhead to capture the sound from the entire room, for example. In still other environments, the microphones may be mounted to a wall facing towards the audio sources, for example, near a conference table.

Thus, microphones are available in a variety of sizes, form factors, mounting options, and wiring options to suit the needs of a given application. Moreover, the different microphones can be designed to produce different polar response patterns, including, for example, omnidirectional, cardioid, subcardioid, supercardioid, hypercardioid, and bidirectional. The polar pattern chosen for a particular microphone (or microphone cartridge included therein) may depend on, for example, where the audio source is located, the desire to exclude unwanted noises, and/or other considerations.

Traditional microphones (such as, e.g., dynamic, crystal, condenser/capacitor (externally biased and electret), boundary, button, etc.) typically have fixed polar patterns and few manually selectable settings. To capture sound in a conferencing environment, several traditional microphones, or microphone cartridges, are used at once to capture multiple audio sources within the environment (e.g., human speakers seated at different sides of a table). However, traditional microphones tend to capture unwanted audio as well, such as room noise, echoes, and other undesirable audio elements. The capturing of these unwanted noises is exacerbated by the use of many microphones. Moreover, while the use of multiple cartridges also allows various independent polar patterns to be formed, the audio signal processing and circuitry required to achieve the different polar patterns can be complex and time-consuming. In addition, traditional microphones may not uniformly form the desired polar patterns and may not ideally capture sound due to frequency response irregularities, as well as interference and reflections within and between the cartridges.

Array microphones can provide several benefits over traditional microphones. Array microphones are comprised of multiple microphone elements aligned in a specific pattern or geometry (e.g., linear, circular, etc.) to operate as a single microphone device. Array microphones can have different configurations and frequency responses depending on the placement of the microphones relative to each other and the direction of arrival for sound waves. For example, a linear array microphone is comprised of microphone elements situated relatively close together along a single axis. One benefit of array microphones is the ability to provide steerable coverage or pick up patterns, which allows the microphones in the array to focus on desired audio sources and reject unwanted sounds, such as room noise. The ability to steer audio pick up patterns also allows for less precise microphone placement, which enables array microphones to be more forgiving. Moreover, array microphones provide the ability to pick up multiple audio sources with a single array or unit, again due to the ability to steer the pickup patterns. Nonetheless, existing arrays comprised of traditional microphones have certain shortcomings, including a relatively large form factor when compared to traditional microphones, and a fixed overall size that often limits placement options in an environment.

Micro-Electrical-Mechanical-System (“MEMS”) microphones, or microphones that have a MEMS element as the core transducer, have become increasingly popular due to their small package size (e.g., allowing for an overall lower profile device) and high performance characteristics (e.g., high signal-to-noise ratio (“SNR”), low power consumption, good sensitivity, etc.). In addition, MEMS microphones are generally easier to assemble and are available at a lower cost than, for example, electret or condenser microphone cartridges found in many existing boundary microphones. However, due to the physical constraints of the MEMS microphone packaging, the polar pattern of a conventional MEMS microphone is inherently omnidirectional, which means the microphone is equally sensitive to sounds coming from any and all directions, regardless of the microphone's orientation. This can be less than ideal for conferencing environments, in particular.

One existing solution for obtaining directionality using MEMS microphones includes placing multiple microphones in an array configuration and applying appropriate beamforming techniques (e.g., signal processing) to produce a desired directional response, or a beam pattern that is more sensitive to sound coming from one or more specific directions than sound coming from other directions. For example, a broadside linear array includes a line of MEMS microphones arranged perpendicular to the preferred direction of sound arrival. A delay and sum beamformer may be used to combine the signals from the various microphone elements so as to achieve a desired pickup pattern. In some broadside arrays, the microphone elements are placed in nested pairs about a central point and may be spaced apart from each by certain predetermined distances in order to cover a variety of frequencies.

Linear or one-dimensional array microphones comprised of MEMS microphones can provide higher performance in a smaller, thinner form factor and with less complexity and cost, for example, as compared to traditional array microphones. Moreover, due to the omni-directionality of the MEMS microphones, such linear arrays typically have arbitrary directivity along the axis of the array. However, such linear arrays also have lobes, or sound pick-up patterns, that are symmetric about the axis of the array with equal sensitivity in all other dimensions, thus resulting in unwanted noise pickup.

Accordingly, there is an opportunity for an array microphone that addresses these concerns. More particularly, there is a need for a thin, low profile, high performing array microphone with improved frequency-dependent directivity, particularly in the audio frequencies that are important for intelligibility, and the ability to reject unwanted sounds and reflections within a given environment, so as to provide full, natural-sounding speech pickup suitable for conferencing applications.

### SUMMARY

The invention is intended to solve the above-noted and other problems by providing an array microphone and microphone system that is designed to, among other things, (1) provide a one-dimensional form factor that has added directivity, for most, if not all, frequencies, in dimensions that, conventionally, have equal sensitivity in all directions; (2) achieve the added directivity by placing a row of first microphones along a first axis, and for each first microphone, placing one or more additional microphones along a second axis orthogonal to the first microphone so as to form a plurality of microphone sets, and by configuring each microphone set to cover one or more of the desired octaves for the one-dimensional array microphone; (3) provide an audio output that utilizes a beamforming pattern selected based on a direction of arrival of the sound waves captured by the microphones in the array, the selected beamforming pattern providing increased rear rejection and steering control; and (4) have high performance characteristics suitable for conferencing environments, including consistent directionality at different frequency ranges, high signal-to-noise ratio (SNR), and wideband audio coverage.

For example, one embodiment includes an array microphone comprising a plurality of microphone sets arranged in a linear pattern relative to a first axis and configured to cover a plurality of frequency bands. Each microphone set comprises a first microphone arranged along the first axis and a second microphone arranged along a second axis orthogonal to the first microphone, wherein a distance between adjacent microphones along the first axis is selected from a first group consisting of whole number multiples of a first value, and within each set, a distance between the first and second microphones along the second axis is selected from a second group consisting of whole number multiples of a second value.

Another example embodiment provides a method performed by one or more processors to generate an output signal for an array microphone comprising a plurality of microphones and configured to cover a plurality of frequency bands. The method comprises receiving audio signals from the plurality of microphones, the microphones being arranged in microphone sets configured to form a linear pattern along a first axis and extend orthogonally from the first axis; determining a direction of arrival for the received audio signals; selecting one of a plurality of beamforming patterns based on the direction of arrival; combining the received audio signals in accordance with the selected beamforming pattern to generate a directional output for each microphone set; and aggregating the outputs to generate an overall array output.

Another example embodiment provides a microphone system comprising: an array microphone configured to cover a plurality of frequency bands, the array microphone comprising a plurality of microphones arranged in microphone sets configured to form a linear pattern along a first axis and extend orthogonally from the first axis; a memory configured to store program code for processing audio signals captured by the plurality of microphones and generating an output signal based thereon; and at least one processor in communication with the memory and the array microphone, the at least one processor configured to execute the program code in response to receiving audio signals from the array microphone. The program code is configured to receive audio signals from the plurality of microphones; determine a direction of arrival for the received audio signals; select one of a plurality of beamforming patterns based on the direction of arrival; combine the received audio signals in accordance with the selected beamforming pattern to generate a directional output for each microphone set; and aggregate the outputs to generate an overall array output.

Yet another example embodiment provides a microphone system comprising an array microphone configured to cover a plurality of frequency bands and comprising a plurality of microphones arranged in a linear pattern along a first axis of the array microphone and extending orthogonally from the first axis; and at least one beamformer configured to receive audio signals captured by the plurality of microphones and based thereon, generate an array output with a directional polar pattern that is selected based on a direction of arrival of the audio signals, the directional polar pattern being further configured to reject audio sources from one or more other directions.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a top view of an exemplary one-dimensional array microphone, in accordance with one or more embodiments.

FIG. 2 is a schematic diagram of the microphone array of FIG. 1 showing exemplary microphone pair selections in accordance with a first beamforming pattern, in accordance with embodiments.

FIG. 3 is a schematic diagram of the microphone array of FIG. 1 showing exemplary microphone pair selections in accordance with a second beamforming pattern, in accordance with embodiments.

FIG. 4 is a schematic diagram of the microphone array of FIG. 1 showing exemplary microphone pair selections in accordance with a third beamforming pattern, in accordance with embodiments.

FIG. 5 is a block diagram of a microphone system comprising the one-dimensional array microphone of FIG. 1, in accordance with embodiments.

FIG. 6 is a block diagram of a sum and difference beamformer included in the microphone system of FIG. 5, in accordance with embodiments.

FIG. 7 is a block diagram of an aggregation beamformer included in the microphone system of FIG. 5, in accordance with embodiments.

FIG. 8 is a block diagram of a linear delay and sum beamformer included in the microphone system of FIG. 5, in accordance with embodiments.

FIG. 9 is a flowchart illustrating an exemplary method for generating a beamformed output signal for a one-dimensional array microphone, in accordance with one or more embodiments.

FIGS. 10A and 10B are side and top views, respectively, of the array microphone of FIG. 1 positioned on top of a table within a conferencing environment, in accordance with one or more embodiments.

FIG. 11A is a polar plot showing a select polar response of the array microphone shown in FIG. 10A, perpendicular to the table, in accordance with one or more embodiments.

FIG. 11B is a polar plot showing a select polar response of the array microphone shown in FIG. 10B, within the plane of the table, in accordance with one or more embodiments.

FIG. 12 is a polar plot showing select polar responses of the array microphone of FIG. 1, in accordance with one or more embodiments.

FIG. 13 is a front view of the array microphone of FIG. 1 mounted to a vertical wall within a conferencing environment, in accordance with embodiments.

FIG. 14 is a directional response plot of the array microphone shown in FIG. 13, in accordance with embodiments.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

Systems and methods are provided herein for a high performing array microphone with a one-dimensional form factor configured to provide good directivity at various frequencies, including higher frequencies within the audible range, and a high signal-to-noise ratio (SNR). In particular, the array microphone comprises a first plurality of microphones arranged along a first axis to achieve coverage of desired frequency bands or octaves, and a second plurality of microphones arranged orthogonal to the first axis, and the microphones arranged thereon, to achieve directional polar patterns for the covered octaves. Exemplary embodiments include arranging the microphones in multiple sets, each set including a first microphone positioned on the first axis and one or more additional microphones positioned on a second axis that is perpendicular to the first axis and aligned orthogonal to the first microphone. In embodiments, the microphones of each set can be combined to create a narrowed beam pattern normal to the array microphone, or narrowed cardioid polar patterns directed within the dimension of the microphone set, depending on the particular application or environment. In both cases, the array microphone lobes can be directed towards a desired sound source and thus, are better able to reject unwanted sound sources and reflections in the environment. In preferred embodiments, the microphones are MEMS transducers or other omnidirectional microphones.

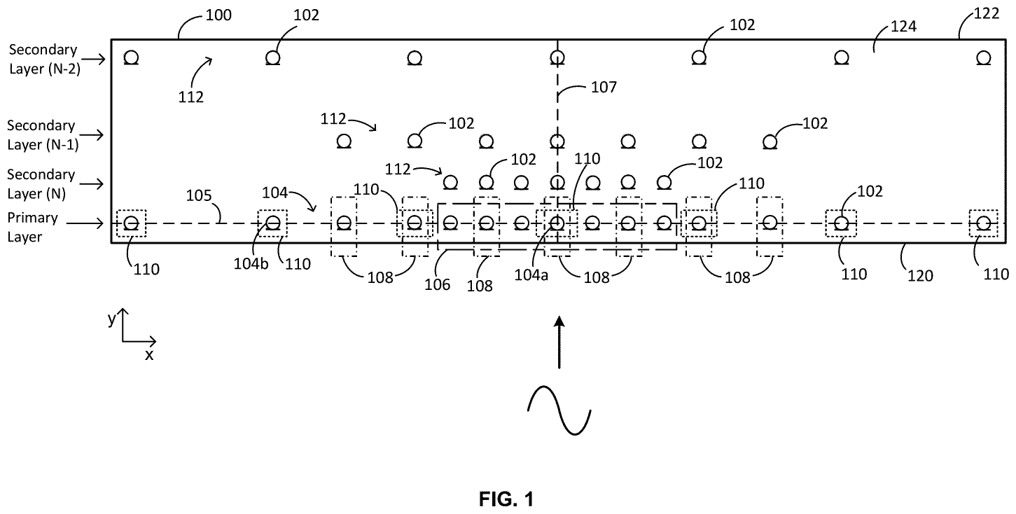

FIG. 1 illustrates an exemplary array microphone 100 for detecting sounds from one or more audio sources at various frequencies, in accordance with embodiments. The array microphone 100 may be utilized in a conferencing environment, such as, for example, a conference room, a boardroom, or other meeting room where the audio sources may include one or more human speakers. Other sounds may be present in the environment which may be undesirable, such as noise from ventilation systems, other persons, audio/visual equipment, electronic devices, etc. In a typical situation, the audio sources may be seated in chairs at a table, although other configurations and placements of the audio sources are contemplated and possible, including, for example, audio sources that move about the room. The array microphone 100 may be placed on a table, lectern, desktop, ceiling, or other horizontal surface in the conferencing environment, as well as on a wall or other vertical surface, in order to detect and capture sound from the audio sources, such as speech spoken by human speakers.

The array microphone 100 includes a plurality of microphones 102 (also referred to herein as “transducers” and “cartridges”) capable of forming multiple pickup patterns in order to optimally or consistently detect and capture sound from the audio sources. The polar patterns that can be formed by the array microphone 100 may depend on the placement of the microphones 102 within the array 100, as well as the type of beamformer(s) used to process the audio signals generated by the microphones 102. For example, a sum and differential beamformer may be used to form a cardioid, subcardioid, supercardioid, hypercardioid, bidirectional, and/or toroidal polar pattern directed to a desired sound source. Additional polar patterns may be created by combining the original polar patterns and steering the combined pattern to any angle along the plane of, for example, the table on which the array microphone 100 rests. Other beamforming techniques may be utilized to combine the outputs of the microphones, so that the overall array microphone 100 achieves a desired frequency response, including, for example, lower noise characteristics, higher microphone sensitivity, and coverage of discrete frequency bands, as described in more detail herein. Although FIG. 1 shows a specific number of microphones, other amounts of microphones 102 (e.g., more or fewer) are possible and contemplated.

In preferred embodiments, each of the microphones 102 may be a MEMS (micro-electrical mechanical system) transducer with an inherent omnidirectional polar pattern. In other embodiments, the microphones 102 may have other polar patterns, may be any other type of omnidirectional microphone, and/or may be condenser microphones, dynamic microphones, piezoelectric microphones, etc. In still other embodiments, the arrangement and/or processing techniques described herein can be applied to other types of arrays comprised of omnidirectional transducers or sensors where directionality is desired (such as, e.g., sonar arrays, radio frequency applications, seismic devices, etc.).

Each of the microphones 102 can detect sound and convert the sound into an audio signal. In some cases, the audio signal can be a digital audio output (e.g., MEMS transducers). For other types of microphones, the audio signal may be an analog audio output, and components of the array microphone 100, such as analog to digital converters, processors, and/or other components, may process the analog audio signals to ultimately generate one or more digital audio output signals. The digital audio output signals may conform to the Dante standard for transmitting audio over Ethernet, in some embodiments, or may conform to another standard. In certain embodiments, one or more pickup patterns may be formed by a processor of the array microphone 100 from the audio signals of the microphones 102, and the processor may generate a digital audio output signal corresponding to each of the pickup patterns. In other embodiments, the microphones 102 may output analog audio signals and other components and devices (e.g., processors, mixers, recorders, amplifiers, etc.) external to the array microphone 100 may process the analog audio signals.

As shown in FIG. 1, the microphones 102 include a first plurality of microphones 104 linearly arranged along a length of the array microphone 100 and perpendicular to a preferred or expected direction of arrival for incoming sound waves. The first plurality of microphones 104 (also referred to herein as “first microphones”) are disposed along a common axis of the array microphone 100, such as first axis 105. The first microphones 104 may be arranged in a linear array pattern configured to cover a plurality of frequency bands using one or more beamformers or other audio processing techniques. In particular, the linear pattern can be configured to operate in different octaves (e.g., 600-1200 Hertz (Hz), 1200-2400 Hz, 2400-4800 Hz, etc.) within the covered plurality of frequency bands, so that the overall beam pattern for the array microphone 100 remains essentially constant from octave to octave. For example, the linear pattern may be implemented using a sub-band-based scaled aperture (SSA) approach that uses a different array aperture for each octave, so that progressively lower frequency octaves are processed by progressively wider linear arrays. In order to enhance spatial resolution, the linear array aperture may be doubled when moving from a higher octave to the next lower one.

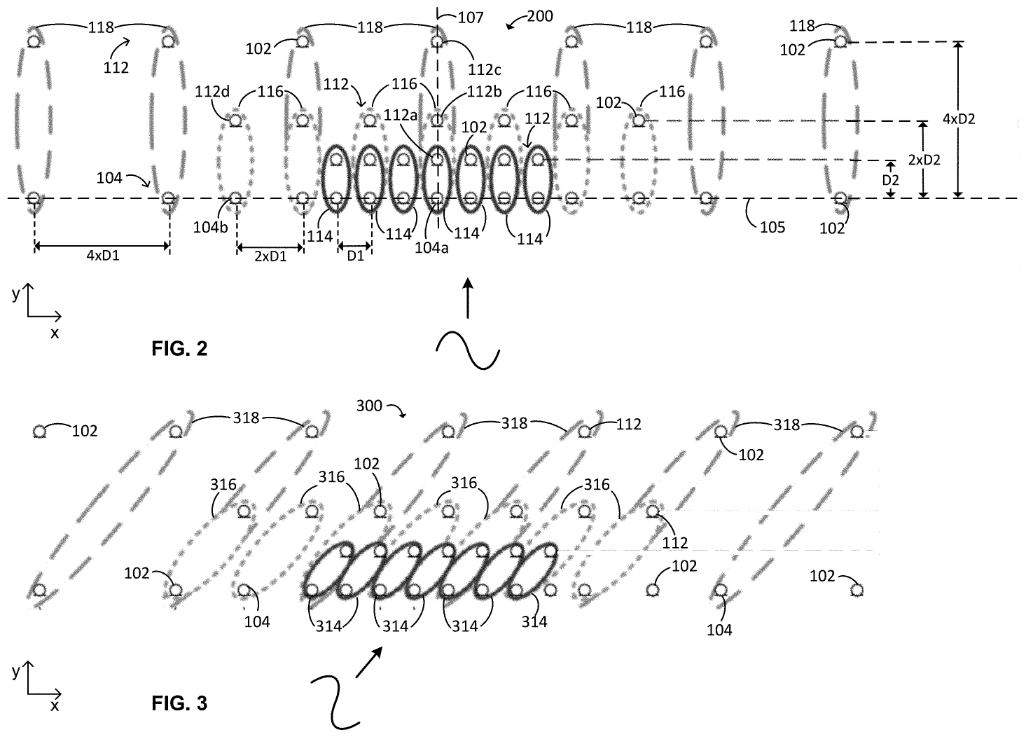

For example, referring additionally to FIG. 2, the first microphones 104 may include a first group of microphones 106 that are spaced apart from each other by a first distance, D1, to form a first sub-array configured to cover a first, or Nth, frequency octave. The first microphones 104 also include a second group of microphones 108 that are configured to form a second sub-array for covering a second, or next lower, frequency octave (e.g., (N−1)th octave) by spacing the microphones 108 apart by a second distance that is twice the first distance, D1. Similarly, a third group 110 of the first microphones 104 may be configured to form a third sub-array for covering a third, still lower, octave (e.g., (N−2)th octave) by spacing the microphones 110 apart by a third distance that is twice the second distance, or four times the first distance, D1. In other words, the distance or spacing between the first microphones 104 may be halved for each octave's worth of frequencies, or increased by a factor of 2 for each decreasing octave. As a result, the microphones 106 for covering the highest, or Nth, octave are closest together, or form the smallest aperture size, and the microphones 110 for covering the lowest octave (e.g., (N−2)th octave), and below, are furthest apart, or form the largest aperture size.

In embodiments, the smallest distance value, D1, may be selected based on a desired linear array aperture size for the array microphone 100 and a total number of first microphones 104 being used to form the linear array pattern, as well as the frequency bands that are to be spatially sampled in the array microphone 100. Other design considerations may also determine the D1 value, including, for example, desired locations for the frequency nulls, a desired amount of electrical delay, and criteria for avoiding spatial aliasing. In one example embodiment, the D1 distance is approximately eight millimeters (mm).

In a preferred embodiment, harmonic nesting techniques are used to select the distances between adjacent first microphones 104, such that the linear pattern formed by the sub-arrays 106, 108, and 110 is harmonically nested. As will be understood, arranging the first microphones 104 in harmonically nested sub-arrays (or nests) can be more efficient and economical because one or more of the microphones 104 can be reused as part of multiple sub-arrays, thus reducing the total number of microphones 104 required to cover the octaves of interest for the array microphone 100. For example, because the second and third sub-arrays 108 and 110 are placed at different double multiples (e.g., 2 and 4, respectively) of the distance D1 between the microphones 104 in the first sub-array 106, the first sub-array 106 can be nested within the second and third sub-arrays 108 and 110, and the second sub-array 108 can be nested within the third sub-array 110. As a result, some of the first microphones 104 can be reused for multiple nests. In particular, as shown in FIG. 2, at least three of the microphones 104 in the first nest 106 also form part of the second nest 108, and at least three of the microphones 104 from the second nest 108 also form part of the third nest 110.

As depicted in FIG. 1, the plurality of microphones 102 further includes a second plurality of microphones 112 (also referred to herein as “second microphones” or “additional microphones”) arranged orthogonal to the first microphones 104 for added directivity at the various frequencies or octaves of interest. In particular, each second microphone 112 is added to the array 100 to duplicate one of the first microphones 104 in terms of placement relative to the first axis 105, but is disposed on a different axis that is orthogonal to the corresponding first microphone 104 and perpendicular to the first axis 105, such as, e.g., second axis 107 or another axis parallel thereto (also referred to herein as an “orthogonal axis”). As shown in FIG. 1, the first axis 105 passes through, or intersects with, the second axis 107 at a central point (or midpoint) of the first axis 105.

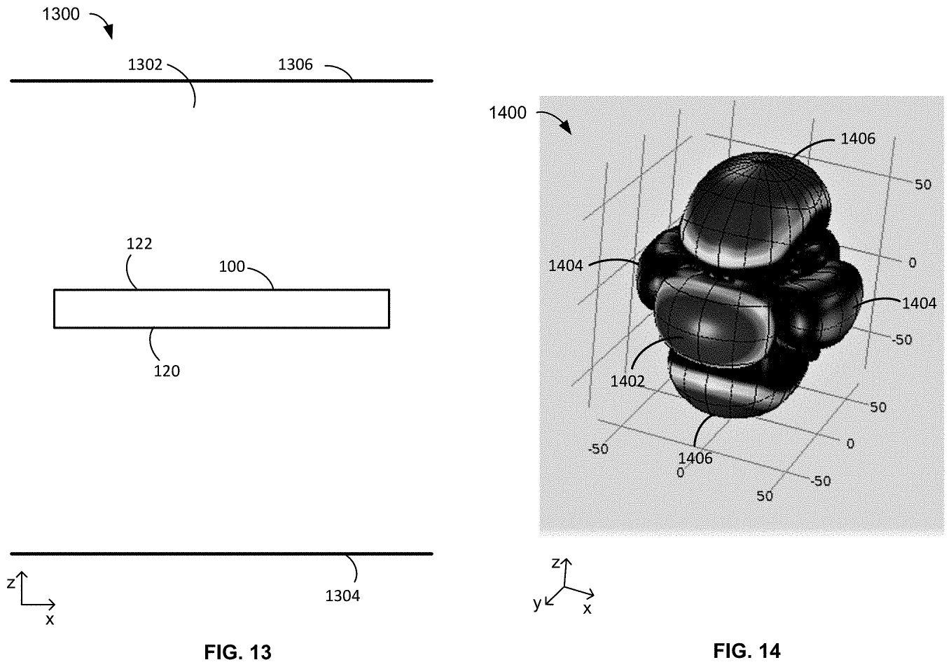

In some embodiments, the first axis 105 coincides with an x-axis of the array microphone 100, and the second axis 107 coincides with a y-axis of the array microphone 100, such that the array microphone 100 lies in the x-y plane, as shown in FIG. 1. For example, when the array microphone 100 is placed on a table or other horizontal surface, the microphones 102 may be planarly arranged relative to the table, or in a first plane that is parallel to a top plane of the table. In other embodiments, the second axis 107 may be another one of the orthogonal axes of the array microphone 100, such as, e.g., the z-axis, depending on the orientation of the microphone 100. For example, when the array microphone 100 is placed on a wall or other vertical surface, the microphones 102 may be planarly arranged relative to the wall, or in a second plane that is parallel to a front plane of the wall, as shown in FIG. 13. In still other embodiments, the array microphone can be suspended in free space. In such cases, the orientation can take on either of the previous orientations, depending on the desired acoustic effect and room configuration.

In embodiments, each second microphone 112 and the first microphone 104 being duplicated thereby jointly form a microphone set, or pair, that is configured to operate in a frequency octave covered by the duplicated microphone 104. For example, in each microphone set, a spacing or distance between the first microphone 104 and the corresponding second microphone 112 along the orthogonal axis can be selected based on the frequency octave covered by that set. Moreover, the first and second microphones 104 and 112 of each microphone set may be treated or handled as a single microphone “element” or unit of the array microphone 100 by acoustically combining the microphones 104 and 112 to create a new pickup pattern for that microphone set (e.g., using appropriate beamforming techniques). In some embodiments, various microphone sets can be further grouped together as sub-arrays to produce one or more combined outputs for the array microphone 100. As an example, all of the microphone sets configured to cover the first octave (e.g., N) can be combined or aggregated to create a sub-array for operating in that octave (e.g., using appropriate beamforming techniques). Each of the various sub-arrays may be further aggregated to create an overall output for the array microphone 100 that has an essentially constant beamwidth, for example.

As an example, FIG. 2 illustrates a plurality of microphone sets 114, 116, and 118 formed from the first and second microphones 104 and 112 of the array microphone 100, in accordance with embodiments. A first group of microphone sets 114 includes the first microphones 104 from the first nest 106 for covering the first, or Nth, octave and the second microphones 112 added to duplicate the first nest 106. In the microphone sets 114, each second microphone 112 is disposed a first distance, D2, from the corresponding first microphone 104. A second group of microphone sets 116 includes the first microphones 104 from the second nest 108 for covering the second, or (N−1)th, octave and the second microphones 112 added to duplicate the second nest 108. In the microphone sets 116, each second microphone 112 is disposed a second distance that is twice the first distance, D2, from the corresponding first microphone 104. The array microphone 100 may further include a third group of microphone sets 118 comprising the first microphones 104 from the third nest 110 for covering the third, or (N−2)th, octave and the second microphones 112 added to duplicate the third nest 110. In the microphone sets 118, each second microphone 112 is disposed a third distance that is four times the first distance, D2, from the corresponding first microphone 104.

Thus, like the distances between adjacent first microphones 104 along the first axis 105, the distance between the microphones 104 and 112 of a given microphone set are halved with each octave's worth of frequencies, or increased by double multiples (i.e. a factor of 2) with each decreasing octave. In embodiments, the distance D2 between the microphones 104 and 112 in the first plurality of microphone sets 114 may be equal to a half wavelength of a desired frequency from the octave covered by the sets 114 (i.e. the Nth octave), for example, to create nulls at the desired frequency. The distance D2 may also be selected to optimize cardioid formation when combining the microphones 104 and 112 of a given microphone set to produce a combined output, as described below. In one example embodiment, the D2 distance is approximately 16 mm.

As shown in FIG. 2, a number of the microphone sets may include the same first microphone 104 and therefore, may be located on the same orthogonal axis. This arrangement is due, at least in part, to the harmonic nesting of the first microphones 104 along the first axis 105 and the coverage of multiple octaves by several of the first microphones 104. More specifically, each first microphone 104 that is configured to cover a number of frequency octaves may be duplicated by an equal number of second microphones 112 disposed at appropriate e.g., (frequency-dependent) distances along the same orthogonal axis, thus creating co-located microphone sets. In other words, the total number of second microphones 112 that may be located on the same orthogonal axis depends on the number of octaves covered by the first microphone 104 of that set. As an example, in FIG. 1, a first microphone 104a is included in all three of the nests 106, 108, and 110 and therefore, is used to cover all three octaves (e.g., N, N−1, and N−2). Accordingly, in FIG. 2, the first microphone 104a is paired with three different second microphones 112a, 112b, and 112c in order to provide coverage for each of the three octaves. Conversely, in FIG. 1, a first microphone 104b is included in just one nest 110 and therefore, is used to cover one octave (e.g., N−1). As a result, in FIG. 2, the first microphone 104b is paired with only one second microphone 112d.

In embodiments, the plurality of microphone sets formed by the microphones 102 are arranged orthogonal relative to the first axis 105 in order to maintain the linear array pattern created by the first microphones 104 along the first axis 105. More specifically, the first microphones 104 may constitute a primary, or top, layer of the array microphone 100, and the additional or second microphones 112 may be disposed in the array 100 so as to form multiple secondary, or lower, layers that are arranged orthogonal to, or spatially behind, the primary layer. This layered arrangement of the microphones 102 allows the array microphone 100 to have a thin, narrow form factor similar to that of a one-dimensional or linear array microphone. For example, an overall length and width of a front face 120 of the array microphone 100 may be largely determined by the dimensions of the primary layer, or more specifically, the aperture size and other physical characteristics of each first microphone 104, as well as the amount of space (e.g., D1 or a whole number multiple thereof) between adjacent microphones 104 within the primary layer. In some cases, the front face 120 may coincide with, or constitute, an overall aperture of the array microphone 100.

An overall depth of the array microphone 100, or the distance between the front face 120 and a rear face 122 of the array 100 (e.g., along the y-axis), may be determined by the number of secondary layers included in the array microphone 100 and the spacing between each layer. The exact number of secondary layers included in the array 100 may depend on the total number of octaves to be covered by the array microphone 100, which in turn may determine the distances between each layer, as described herein. In some cases, the number of secondary layers, or covered octaves, may be determined by physical limitations on a device housing for the array microphone 100 (e.g., a maximum depth of the housing). In the illustrated embodiment, the overall depth of the array microphone 100 may be determined by the distance between the primary layer and the last secondary layer (e.g., four times distance D2) because the other secondary layers are nested within the space between the first and last layers. In some embodiments, harmonic nesting techniques are used to select the distances between the primary layer and each of the secondary layers. While the illustrated embodiment shows three secondary layers configured to provide added directivity for three different octaves (e.g., N, N−1, and N−2), other embodiments may include more layers to cover more octaves, thus increasing the depth of the array 100, or fewer layers to cover fewer octaves, thus decreasing the array depth.

The array microphone 100 may further include one or more supports 124 (such as, e.g., a substrate, printed circuit board (PCB), frame, etc.) for supporting the microphones 102 within the housing of the array microphone 100. In embodiments, each of the microphones 102 may be mechanically and/or electrically coupled to at least one of the support(s) 124. In some cases, each layer of the microphones 102 may be disposed on an individual support 124, and the various supports 124 may be stacked side by side within the microphone housing (e.g., in the y-axis direction). In the case of a PCB support 124, the microphones 102 may be MEMS transducers that are electrically coupled to one or more PCBs, and each PCB may be electrically coupled to one or more processors or other electronic device for receiving and processing audio signals captured by the microphones 102. The support(s) 124 may have any appropriate size or shape. In some cases, the support(s) 124 may be sized and shaped to meet the constraints of a pre-existing device housing and/or to achieve desired performance characteristics (e.g., select operating bands, high SNR, etc.). For example, a maximum width and/or length of the support 124 may be determined by the overall height and/or length of a device housing for the array 100.

In general, the array microphone 100 shown in FIGS. 1 and 2 may be configured for broadside usage, or to preferably pick-up sounds arriving generally perpendicular to the front microphones 104 and ignore or isolate sounds from the other directions. According to embodiments, the array microphone 100 can be configured to generate sound beams (or main lobe) directed towards either of the broadside directions, so as to capture sounds arriving broadside at zero degrees relative to the front microphones 104, or broadside at 180 degrees relative to the front microphones 104. That is, the array microphone 100 may be agnostic to the direction of arrival within the x-y plane. When the sound source is located at 180 degrees broadside, the roles of the microphones 102 may be flipped. For example, the primary layer, or first microphones 104, may serve as a secondary layer and one of the secondary layers of additional microphones 112 (e.g., layer N in FIG. 1) may serve as the primary layer. In this manner, the array microphone 100 can be configured to generate a directional polar pattern towards either broadside direction of arrival and isolate sounds coming from all other directions.

In addition, appropriate beamforming techniques may be used to steer the sound beams formed by the individual microphone pairs (e.g., microphone sets 114, 116, and 118) towards a desired audio source that is not located broadside. For example, a linear delay and sum beamforming approach may be used to add a certain amount of delay to the audio signals for each microphone set, the delay determining a beam-steering angle for that set. The amount of delay may depend on frequency, as well as distance between the microphone set and the audio source, for example. Through such frequency-dependent steering, a constant beamwidth may be achieved for the array microphone 100 over a wide range of frequencies.

In embodiments, the array microphone 100 may be agnostic to the direction of arrival within the x-y plane for non-broadside or oblique angle conditions as well. For example, the array microphone 100 can capture sounds arriving at a first oblique angle relative to the front face 120, as well as sounds arriving at an equal but opposite angle relative to the rear face 122, or 180 degrees greater than the first oblique angle relative to the front face 120 of the array microphone. In such cases, the primary and secondary layers of microphones may be flipped or interchanged in the same manner as described herein for the broadside conditions.

In embodiments, due to the unique geometry or layout of the microphones 102 in the array 100, the first microphones 104 and the second microphones 112 can be paired in more than one way to create microphone sets for covering the same desired octaves. A specific pattern or arrangement of the microphone pairs may be selected for the array microphone 100 depending on a preferred direction of arrival for the sound waves. In particular, the plurality of microphone sets may be formed according to one or more beamforming patterns for broadside usage of the array microphone 100 when the direction of arrival for sound waves is perpendicular to the first microphones 104 or the front face 120 of the array microphone 100. Alternatively, the plurality of microphone sets may be formed according to one or more beamforming patterns for oblique angle usage of the array microphone 100 when the direction of arrival for sound waves is at an angle relative to the front face 120 of the array microphone 100.

For example, FIG. 2 shows a first broadside beamforming pattern 200 configured for a direction of arrival that is perpendicular to the front microphones 104 and at zero degrees relative to the front face 120 of the array microphone 100. In embodiments, a second broadside beamforming pattern (not shown) may be used when the direction of arrival for the sound waves is perpendicular to the front microphones 104 but approaching at 180 degrees relative to the front face 120 of the array microphone 100. The second broadside beamforming pattern may be the same as the beamforming pattern 200 shown in FIG. 2, except that the primary layer of microphones 104 switches roles with one of the secondary layers of microphones 112, since the sound waves will reach the second microphones 112 before reaching the first microphones 104.

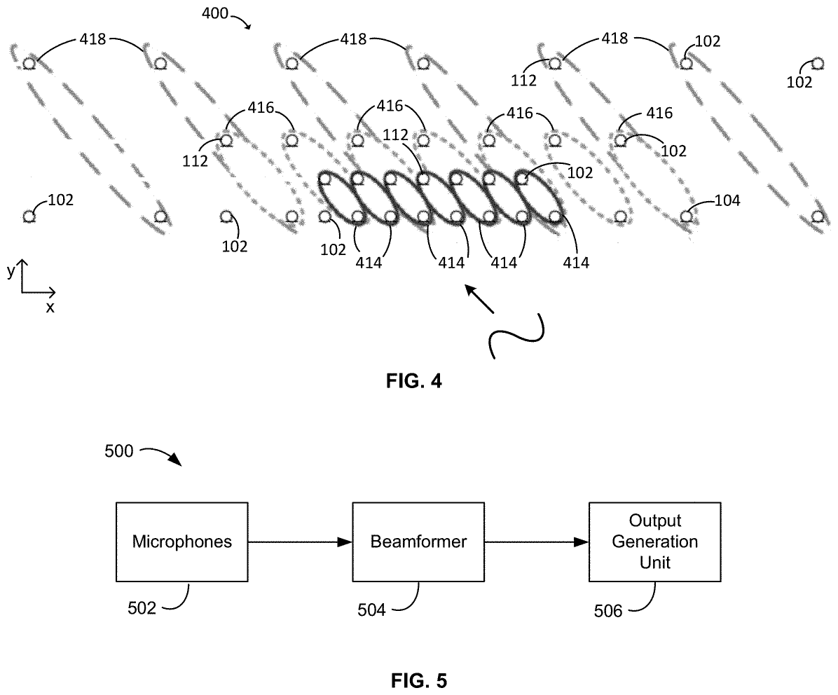

FIG. 3 depicts a first oblique angle beamforming pattern 300 configured for a direction of arrival that is greater than 30 degrees relative to the first axis 105 (such as, e.g., 45 degrees). The beamforming pattern 300 includes a first plurality of microphone sets 314 configured for coverage of the first, or Nth, octave, similar to the first plurality of sets 114 in FIG. 2, a second plurality of microphone sets 316 configured for coverage of the second, or (N−1)th, octave, similar to the second plurality of sets 116 in FIG. 2, and a third plurality of microphone sets 318 configured for coverage of the third, or (N−2)th octave, similar to the third plurality of sets 118 in FIG. 2. Each of the microphone sets in the pattern 300 comprises the same first microphone 104 as the corresponding microphone set in the first beamforming pattern 200, but a different second microphone 112. In particular, for each set, the first microphone 104 is now paired with the second microphone 112 that is positioned approximately 45 degrees from the first microphone 104 (or diagonally to the right as shown in FIG. 3), rather than the second microphone 112 that is directly orthogonal to the corresponding first microphone 104 (as in FIG. 2). In embodiments, the same microphone sets are formed when the direction of arrival is opposite that shown in FIG. 4 (i.e. incident on or directed towards the rear face 122), but the second microphone 112 and the first microphone 104 are interchanged in terms of functionality.

FIG. 4 depicts a second oblique beamforming pattern 400 configured for a direction of arrival that is about 90 degrees offset from the direction of arrival shown in FIG. 3, or greater than 120 degrees (such as, e.g., 135 degrees or −45 degrees), relative to the first axis 105. The beamforming pattern 400 includes a first plurality of microphone sets 414 configured for coverage of the first, or Nth, octave, similar to the first plurality of sets 114 in FIG. 2, a second plurality of microphone sets 416 configured for coverage of the second, or (N−1)th, octave, similar to the second plurality of sets 116 in FIG. 2, and a third plurality of microphone sets 418 configured for coverage of the third, or (N−2)th octave, similar to the third plurality of sets 118 in FIG. 2. Like the pattern 300, each of the microphone sets in the pattern 400 comprises the same first microphone 104 as the corresponding microphone set from the first beamforming pattern 200, but a different second microphone 112. In particular, for each set, the first microphone 104 is now paired with the second microphone 112 that is positioned approximately −45 degrees from the first microphone 104 (or diagonally to the left as shown in FIG. 4), rather than the second microphone 112 that is directly orthogonal to the corresponding first microphone 104 (as in FIG. 2). In embodiments, the same microphone sets can be formed when the direction of arrival is opposite that shown in FIG. 3 (i.e. incident on or directed towards the rear face 122), but the second microphone 112 and the first microphone 104 are interchanged in terms of functionality.

According to embodiments, the alternative or angled beamforming patterns 300 and 400 enable the array microphone 100 to cover oblique or slanted direction of arrival angles with minimal, or less, steering, for example, as would be required if using the broadside pattern 200. The oblique patterns 300 and 400 also mitigate lobe deformation as the steering angle tends toward that of an endfire array (e.g., 0 or 180 degrees relative to the first axis 105). Moreover, the ability to select a suitable beamforming pattern based on direction of arrival improves the steered directionality of the array microphone 100 without relying on computationally-heavy signal processing, as is required by conventional array microphones. The diagonal or 45-degrees beamforming patterns 300 and 400 shown in FIGS. 3 and 4, respectively, take advantage of the specific geometry of the array microphone 100, which has a symmetrical, grid-like pattern created by the layered or orthogonal arrangement of the microphones 102 and by the harmonically-nested configurations of the additional layers relative to the primary layer and of the first microphones 104 relative to each other within the primary layer. Other embodiments may include oblique beamforming patterns configured for different direction of arrival angles, for example, depending on the specific values selected for the first distance D1 between the first microphones 104 and/or the second distance D2 between the primary layer and the first secondary layer.

In the illustrated embodiment, the first broadside pattern 200 places each of the microphones 102 into a microphone set or pair, while each of the oblique patterns 300, 400 excludes one or more of the microphones 102 from the microphone pairings. Moreover, in each pattern 300, 400, the third group of microphone sets 318, 418 includes only six microphone pairs, while the third group of microphone sets 118 in the pattern 200 includes seven microphone pairs. These differences between the patterns 200, 300 and 400 may be due to the specific arrangement and number of microphones 102 in the array microphone 100. In some embodiments, the array microphone 100 may include additional microphones 102 disposed at locations that are designed to increase the number of microphone sets in each of the third groups 318 and 418 from six to seven. For example, in such cases, the array microphone 100 may include an extra second microphone 112 in the third secondary layer and/or an extra first microphone 104 in the primary layer in order to create seventh pairings for one or both of the oblique patterns 300 and 400.

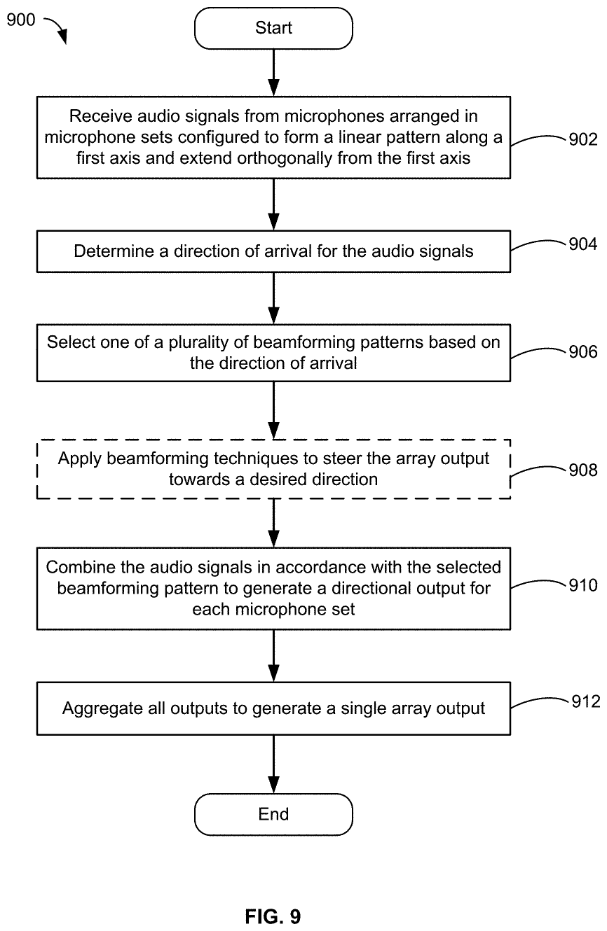

FIG. 5 illustrates an exemplary microphone system 500, in accordance with embodiments. The microphone system 500 comprises a plurality of microphones 502 similar to the microphones 102, a beamformer 504, and an output generation unit 506. Various components of the microphone system 500 may be implemented using software executable by one or more computers, such as a computing device with a processor and memory, and/or by hardware (e.g., discrete logic circuits, application specific integrated circuits (ASIC), programmable gate arrays (PGA), field programmable gate arrays (FPGA), etc.). For example, some or all components of the beamformer 504 may be implemented using discrete circuitry devices and/or using one or more processors (e.g., audio processor and/or digital signal processor) (not shown) executing program code stored in a memory (not shown), the program code being configured to carry out one or more processes or operations described herein, such as, for example, method 900 shown in FIG. 9. Thus, in embodiments, the system 500 may include one or more processors, memory devices, computing devices, and/or other hardware components not shown in FIG. 5. In a preferred embodiment, the system 500 includes at least two separate processors, one for consolidating and formatting all of the microphone elements and another for implementing DSP functionality.

The microphones 502 may include the microphones 102 of the array microphone 100 shown in FIG. 1, or other microphone designed in accordance with the techniques described herein. The beamformer 504 may be in communication with the microphones 502 and may be used to apply appropriate beamforming techniques to the audio signals captured by the microphone elements 502 to create a desired pickup pattern, such as, e.g., a first order polar-pattern (e.g., cardioid, super-cardioid, hypercardioid, etc.), and/or steer the pattern to a desired angle to obtain directionality. For example, in some embodiments, the beamformer 504 may be configured to combine the microphones 502 to form a plurality of microphone pairs, combine the pairs to form a plurality of sub-arrays, and combine the sub-arrays to create a linear or one-dimensional array output with a directional polar pattern, such as, e.g., a cardioid pickup pattern. The output generation unit 506 may be in communication with the beamformer 504 and may be used to process the output signals received from the beamformer 504 for output generation via, for example, loudspeaker, telecast, etc.

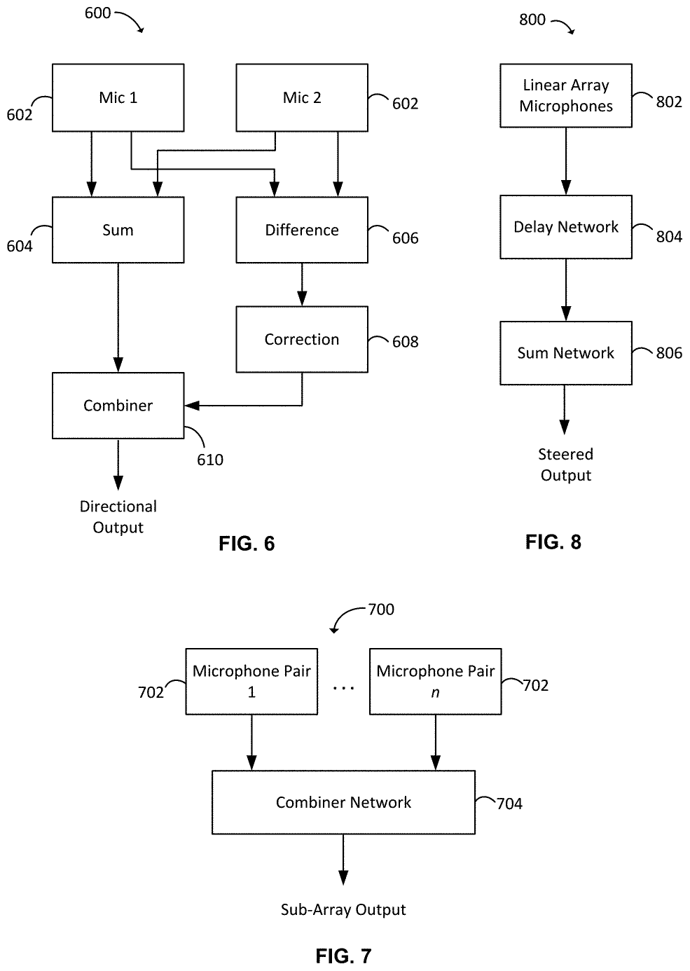

In embodiments, the beamformer 504 may include one or more components to facilitate processing of the audio signals received from the microphones 502, such as, e.g., sum and difference cardioid formation beamformer 600 of FIG. 6, sub-array combining beamformer 700 of FIG. 7, and/or linear delay and sum steering beamformer 800 of FIG. 8. In some cases, the various beamformers 600, 700, and/or 800 may be in communication with each other in order to generate an output for the overall array microphone. In some cases, the beamformer 504 includes multiple instances of a given beamformer 600, 700, or 800. Other beamforming techniques or combinations thereof may also be performed by the beamformer 504 to provide a desired output.

Referring now to FIG. 6, sum and difference beamformer 600 may be configured to combine audio signals captured by a given set or pair of microphones 602 and generate a combined output signal for said microphone pair that has a directional polar pattern, in accordance with embodiments. More specifically, beamformer 600 may be configured to use appropriate sum and difference techniques on each set of first and second microphones 602 arranged orthogonally to a first axis, or front face, of an array microphone, such as, e.g., array microphone 100 in FIG. 1, to form cardioid elements with narrowed lobes (or sound pick-up patterns), for example, as compared to the full omni-directional polar pattern of the individual microphones 602. As an example, the first microphone 602 (or Mic 1) may include one of the first microphones 104 disposed along the first axis 105 of the array microphone 100, and the second microphone 602 (or Mic 2) may include the second microphone 112 that is disposed on an orthogonal axis of the array microphone 100 to duplicate said first microphone 104. A spacing or distance between the first and second microphones 602 along said orthogonal axis may be selected based on the frequency octave covered by the first microphone 602.

As shown in FIG. 6, a first audio signal received from the first microphone 602 (e.g., Mic 1) and a second audio signal received from the second microphone 602 (e.g., Mic 2) are provided to a summation component 604 of the beamformer 600, as well as a difference component 606 of the same. The summation component 604 may be configured to calculate a sum of the first and second audio signals (e.g., Mic 1+Mic 2) to generate a combined or summed output for the pair of microphones 602. The difference component 606 may be configured to subtract the second audio signal from the first audio signal (e.g., Mic 1−Mic 2) to generate a differential signal or output for the first and second microphones 602. As an example, the summation component 604 may include one or more adders or other summation elements, and the difference component 606 may include one or more invert-and-sum elements.

As also shown, beamformer 600 further includes a correction component 608 for correcting the differential output generated by the difference component 606. The correction component 608 may be configured to correct the differential output for a gradient response caused by the difference calculation. For example, the gradient response may give a 6 dB per octave slope to the frequency response of the microphone pair. In order to generate a first-order polar pattern (e.g., cardioid) for the microphone pair over a broad frequency range, the differential output must be corrected so that it has the same magnitude as the summation output. In a preferred embodiment, the correction component 608 applies a correction value of (c*d)/(j*w) to the difference output to obtain a corrected difference output for the microphone pair 602 (e.g., (Mic 1−Mic 2)*((c*d)/(j*co))), where c equals the speed of sound in air at 20 degrees Celsius, d equals the distance between the first and second microphones (e.g., D2 or a whole number multiple thereof), and co equals the angular frequency. In some cases, a second magnitude correction may be performed to match the sensitivity of the difference component to that of the summation component.

The beamformer 600 also includes a combiner 610 configured to combine or sum the summed output generated by the summation component 604 and the corrected difference output generated by the correction component 608. The combiner 610 thus generates a combined output signal with directional polar pattern (e.g., cardioid) for the pair of microphones 602, as shown in FIG. 6.

In some embodiments, the beamformer 600 can be configured to receive audio signals from first and second sub-arrays, instead of the individual microphones 602, and combine the first and second sub-array signals using the same sum and difference techniques shown in FIG. 6. For example, the first and second sub-array signals may be summed by the summation component 604 and also provided to the difference component 606 and the correction component 608 to calculate a corrected difference for the same. The resulting summed output and corrected difference output may be summed or combined together to generate a directional output for the pair of sub-arrays.

In one embodiment, the first sub-array may be a sub-array formed by combining the first microphones 104 within the primary layer of the array microphone 100 that are configured to cover a given frequency octave. Likewise, the second sub-array may be formed by combining the second microphones 112 that are disposed in one of the additional layers of the array 100 to duplicate the microphones 104 of the first sub-array and cover the same frequency octave. In such cases, the combined, directional output generated by the beamformer 600 may be specific to the frequency octave covered by the first and second sub-arrays. Other combinations of the microphones 102 to generate the first and second sub-arrays are also contemplated.

The first and second sub-array signals may be obtained by combining the audio signals captured by the microphones within each sub-array. The exact beamforming technique used to combine these microphone signals may vary depending on how the corresponding sub-array is formed, or how the microphones are arranged within that sub-array (e.g., linear array, orthogonal array, broadside array, endfire array, etc.). For example, audio signals received from microphones arranged in a linear or broadside array may be summed together to generate the sub-array signal. In some cases, the beamformer 600 may be in communication with one or more other beamformers in order to receive the first and second sub-array signals. For example, a separate beamformer may be coupled to the microphones of a given sub-array in order to combine the audio signals received from said microphones and generate a combined output signal for that sub-array.

Referring now to FIG. 7, sub-array beamformer 700 may be configured to combine the outputs for a given number, n, of microphone pairs 702 (e.g., Mic Pair 1 to Mic Pair n) and generate a combined output signal for the sub-array formed by said microphone pairs 702, in accordance with embodiments. For example, referring to FIG. 2, the microphone pairs 702 may be the plurality of microphone sets that form the first group or sub-array 114 for covering the first octave (e.g., Nth octave), the plurality of microphone sets that form the second group or sub-array 116 for covering the second octave (e.g., (N−1)th octave), or the plurality of microphone sets that form the third group or sub-array 118 for covering the third octave (e.g., (N−2)th octave). Other combinations of microphone pairs 702 are also contemplated.

As shown, the beamformer 700 may receive a combined audio signal for each microphone pair 702 and may provide said signals to a combiner network 704 of the beamformer 700. The combiner network 704 may be configured to combine or sum the received signals to generate a combined sub-array output for the microphone pairs 702. In embodiments, the combiner network 704 may include a plurality of adders or other summation elements capable of summing the various audio signals together.

In some embodiments, the beamformer 700 may be in communication with a plurality of other beamformers, such as, e.g., beamformers 600 shown in FIG. 6, in order to receive a combined audio signal for each microphone pair 702. For example, the beamformer 600 may be used to combine the audio signals produced by the first and second microphones 602 (e.g., Mic 1 and Mic 2) and generate a combined output with cardioid formation for said pair of microphones 602. The combined, cardioid output of the beamformer 600 may be provided to the beamformer 700 as the combined audio signal for the first microphone pair 702 (e.g., Mic Pair 1). Similar techniques may be used to provide combined, cardioid outputs to the beamformer 700 for each of the other microphone pairs 702 in the corresponding sub-array. The combiner network 704 can then combine all of the cardioid outputs together to generate a cardioid output for the overall sub-array.

Referring now to FIG. 8, delay and sum beamformer 800 may be configured to steer an overall output of a linear array of microphones 802 towards a desired direction or audio source using appropriate delay and sum techniques, in accordance with embodiments. As shown, the beamformer 800 receives audio signals for the microphones 802 and provides the same to a delay network 804. The delay network 804 may be configured to introduce or add an appropriate delay amount to each of the received audio signals. The delayed signal outputs are then provided to the sum or summation network 806. The summation network 806 combines or aggregates the signals received from the delay network 804 to create a combined output for the overall array that is steered to the desired angle. In embodiments, the delay network 804 may include a plurality of delay elements for applying appropriate delay amounts to respective microphone signals, and the summation network includes a plurality of adders or other summation elements capable of summing the outputs received from the plurality of delay elements.

In embodiments, the microphones 802 may be arranged as a linear or one-dimensional array using techniques described herein, for example, similar to the array microphone 100 shown in FIG. 1. More specifically, the microphones 802 may include a first plurality of microphones (e.g., first microphones 104) that are linearly arranged along a first axis, or front face, of the array microphone, as well as a second plurality of microphones (e.g., second microphones 112) that are arranged orthogonal to the first microphones along one or more different axes perpendicular to the first axis, for example, as shown in FIG. 1. The first and second microphones may form a plurality of microphone sets or pairs that are configured to create a linear pattern relative to the first axis, for example, as shown in FIG. 2. In some cases, the outputs of the microphones 802 in each pair may be combined using appropriate beamforming techniques, such as, e.g., beamformer 600. In such cases, the beamformer 800 may be in communication with one or more beamformers 600 in order to receive a combined audio signal for each of the linearly-arranged microphone pairs. In other embodiments, the beamformer 800 may be in communication with one or more beamformers 700 in order to receive a combined sub-array signal for each of the sub-arrays formed by grouping together the linearly-arranged microphone pairs based frequency octave coverage (e.g., sub-arrays 114, 116, and 118 in FIG. 2).

The amount of delay introduced by the delay network 804 may be based on a desired steering angle for the overall array, the location of the respective microphone 802 in the linear array and/or relative to an audio source, how the microphones 802 are paired, grouped, or otherwise arranged in the array, and the speed of sound. As an example, if an audio source is located at a first end of the linear array microphone, sound from the audio source would arrive at different times at a first set of microphones 802 disposed at the first end as compared to a second set of microphones 802 disposed at the opposing, second end. In order to time align the audio signals from the first end microphones with the audio signals from the second end microphones for appropriate beamforming, a delay may be added by the delay network 804 to the audio signals from the second end microphones. The amount of delay may be equal to the amount of time it takes sound from the audio source to travel between the first end microphones 802 and the second end microphones 802. In addition to determining the amount of delay, the beamformer 800 may determine which of the microphones 802, or microphone sets, to delay based on the desired steering angle, the locations of the microphones 802 within the array, and the location of the audio source, for example.

FIG. 9 illustrates an exemplary method 900 of generating an output signal for an array microphone comprising a plurality of microphones and configured to cover a plurality of frequency bands, in accordance with embodiments. All or portions of the method 900 may be performed by one or more processors (such as, e.g., an audio processor included in the microphone system 500 of FIG. 5) and/or other processing devices (e.g., analog to digital converters, encryption chips, etc.) within or external to the array microphone. In addition, one or more other types of components (e.g., memory, input and/or output devices, transmitters, receivers, buffers, drivers, discrete components, logic circuits, etc.) may also be utilized in conjunction with the processors and/or other processing components to perform any, some, or all of the steps of the method 900. For example, program code stored in a memory of the system 500 may be executed by the audio processor in order to carry out one or more operations of the method 900.

In some embodiments, certain operations of the method 900 may be performed by one or more of the sum-difference cardioid formation beamformer 600 of FIG. 6, the sub-array combining beamformer 700 of FIG. 7, and the linear delay and sum steering beamformer 800 of FIG. 8. The array microphone may be the array microphone 100 described herein and shown in, for example, FIG. 1. The microphones included in the array microphone may be, for example, MEMS transducers which are inherently omnidirectional, other types of omnidirectional microphones, electret or condenser microphones, or other types of omnidirectional transducers or sensors.

Referring back to FIG. 9, the method 900 begins, at block 902, with a beamformer or processor receiving audio signals from a plurality of microphones (e.g., microphones 102 of FIG. 1) arranged in microphone sets configured to form a linear pattern along a first axis (e.g., first axis 105 in FIG. 1) and extend orthogonally from the first axis. More specifically, each microphone set may comprise a first microphone (e.g., one of the first microphones 104 shown in FIG. 1) arranged along the first axis to cover one or more octaves within the plurality of frequency bands covered by the array microphone. Each microphone set may further comprise a second microphone (e.g., one of the second microphones 112 shown in FIG. 1) arranged on a second axis that is orthogonal to the first microphone and perpendicular to the first axis (e.g., second axis 107 in FIG. 1).

In embodiments, each second microphone may be arranged within the array microphone to duplicate one of the first microphones in terms of placement relative to the first axis and frequency coverage. Specifically, each second microphone may be placed at a predetermined distance from the duplicated first microphone (along the orthogonal axis) that is based on the octave covered by the first microphone. As a result, each microphone set may be configured to cover a particular frequency octave. Harmonic nesting techniques may be used to select the arrangement of the first microphones along the first axis and/or the arrangement of the second microphones relative to the first microphones.

The plurality of microphone sets may be further arranged to form a plurality of sub-arrays. For example, the microphone sets may be grouped together based on frequency octave so that each sub-array covers a different octave (e.g., groups 114, 116, and 118 shown in FIG. 2). In some cases, a number of the microphone sets may be located (or co-located) on the same orthogonal axis because they include a common first microphone but different second microphones. In such cases, the first microphone may be configured to cover multiple octaves, and each of the second microphones may be configured to duplicate only one of those octaves, for example, through selection of an appropriate distance from the first microphone. As a result, the co-located second microphones may belong to different sub-arrays even though they are positioned on the same orthogonal axis.

At block 904, the processor or beamformer determines a direction of arrival for the audio signals received from the plurality of microphones at block 902. The direction of arrival may be measured in degrees, or as an angle relative to the first axis 105 of the array microphone 100. The direction of arrival may be determined using one or more beamforming techniques, such as, for example, cross correlation techniques, inter-element delay calculation, and other suitable techniques.

At block 906, the processor or beamformer selects one of a plurality of beamforming patterns for processing the received audio signals based on the direction of arrival identified at block 904. For example, the plurality of beamforming patterns may include a broadside pattern, such as, e.g., beamforming pattern 200 shown in FIG. 2, and at least one oblique angle pattern, such as, e.g., beamforming pattern 300 shown in FIG. 3 and/or beamforming pattern 400 shown in FIG. 4. The broadside pattern may be selected if the direction of arrival is normal to the first axis of the array microphone, or the audio source is positioned perpendicular to the array microphone. If, on the other hand, the direction of arrival is at an angle relative to the first axis, or the audio source is positioned to one side of the array, an appropriate oblique angle pattern may be selected.

In embodiments, the processor or beamformer may access a database (e.g., look-up table) stored in a memory of the microphone system 500 to determine which pattern to use. The database may store direction of arrival values, or ranges of values, that are associated with each pattern. For example, the first oblique angle pattern 300 may be selected if the direction of arrival is around 45 degrees relative to the first axis, or falls within a preset range around 45 degrees (e.g., 0 degrees to 60 degrees). The second oblique angle pattern 400 may be selected if the direction of arrival is around 135 degrees relative to the first axis, or falls within a preset range around 135 degrees (e.g., 120 degrees to 180 degrees). And the broadside pattern 200 may be selected if the direction of arrival falls within a preset range around 90 degrees (e.g., 61 degrees to 121 degrees). Other suitable techniques for selecting an appropriate beamforming pattern based on a detected direction of arrival may also be used.

In some embodiments, the method 900 continues from block 906 to block 908, where the beamformer or processor applies appropriate beamforming techniques to steer the array output towards a desired direction or audio source. For example, all or portions of the steering process in block 908 may be performed by the linear delay and sum steering beamformer 800 of FIG. 8, or by otherwise using delay and sum techniques to steer the output of the linear array microphone to a desired angle. As shown in FIG. 9, the steering techniques may be performed before combining the received audio signals to achieve a desired directional output using the beamforming pattern selected at block 906.

At block 910, the beamformer or processor combines the received audio signals in accordance with the selected beamforming pattern to generate a directional output for each microphone set. In embodiments, combining the received audio signals includes, for each microphone set, combining the audio signal received from the first microphone with the audio signal received from the second microphone, and using a sum-difference beamforming technique to create the directional output. Accordingly, all or portions of block 910 may be performed by sum-difference beamformer 600 of FIG. 6, or by otherwise applying sum and difference cardioid formation techniques to the audio signals received for each microphone set.

In some embodiments, the microphones in each layer of the array microphone may be first combined according to the covered octave to form one or more in-axis sub-arrays for that layer (e.g., nests 106, 108, and 110 in the primary layer shown in FIG. 1). In such cases, the sum-difference techniques, such as the beamformer 600, may be applied to a pair of sub-arrays, instead of a pair of microphones. For example, the sum-difference beamformer 600 may be used to combine the first sub-array 106 from the primary layer of the array microphone 100 shown in FIG. 1 with the first secondary layer that was added orthogonal to the first axis 105 to duplicate the microphones 104 of the first nest 106. This process may be repeated for each of the remaining secondary layers in the array microphone.

At block 912, the beamformer or processor aggregates all of the beamformed outputs generated at block 910 to provide an overall or single array output for the array microphone. As described herein, the microphones of the array microphone may be arranged into sub-arrays using one or more different techniques. At block 912, the outputs of such sub-arrays, regardless of how they are generated, may be aggregated or combined to generate the overall array output. The method 900 may end once the single array output is provided.

As an example, in embodiments where the microphones are combined into microphone sets at block 910 to improve directionality, at block 912 said microphone sets may be further combined into various sub-arrays based on the frequency octave covered by each set. In such embodiments, all or portions of block 912 may be performed by sub-array combining beamformer 700 of FIG. 7 in order to aggregate the directional outputs for each of the microphone pairs within a given sub-array and generate an overall sub-array output for that sub-array. This process may be repeated for each sub-array, or each octave, of the array microphone. The aggregating process in block 912 may further include aggregating or combining the various sub-array outputs to generate the single array output.

Though blocks 902-912 are depicted in FIG. 9, and described herein, as having a particular chronological order, in other embodiments one or more of the blocks may be performed out of order or according to a different sequence. For example, the steering process of block 908 may be performed after block 910 and/or block 912, in some embodiments. More specifically, in such cases, steering techniques may be applied to the array output after the received audio signals are combined to form microphone sets, after the microphone sets are combined to form sub-arrays, or after the sub-arrays are combined to form a single array output.

According to embodiments, the array microphone 100 shown in FIG. 1 and described herein can produce a substantially consistent frequency response across a variety of settings or orientations, including, for example, whether placed on a table or other horizontal surface, mounted to a ceiling, or horizontally attached to a wall. In particular, regardless of the array orientation, the lobes of the array microphone 100 can be directed towards a desired sound source with increased rear rejection and steering control, or isolated forward acceptance, thus improving the array's ability to reject unwanted sound sources and reflections in the room and provide a high signal to noise ratio (SNR). At the same time, there may be slight or small differences in behavior between certain orientations due to the arrangement of the microphones 102 relative to the audio sources.

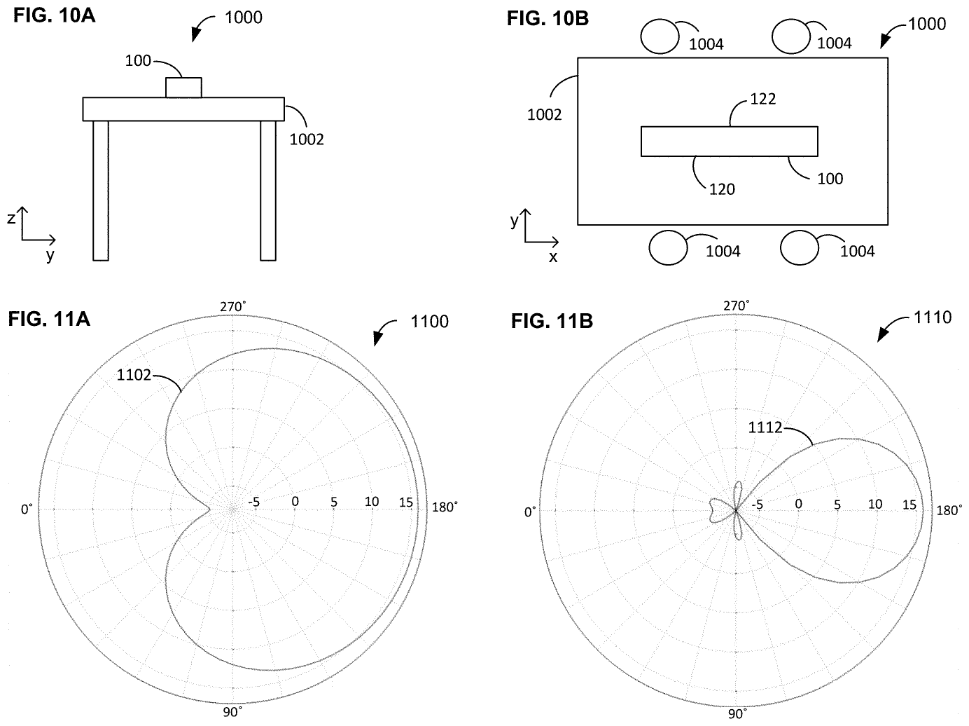

FIGS. 10A and 10B illustrate an exemplary environment 1000 wherein the array microphone 100 is placed on a table 1002, or other horizontal or substantially flat surface, in accordance with embodiments. The table 1002 may be a conference room table, for example, with a plurality of audio sources 1004 (e.g., human speakers) situated or seated around the table 1002. In such environment 1000, the array microphone 100 may be situated so that the front face 120 faces one side of the table 1002 and the rear face 122 faces an opposite side of the table 1002, as shown in FIG. 10B. Because the array microphone 100 is agnostic to direction of arrival within the x-y plane, the array microphone 100 can direct a broadside polar pattern towards either of the two sides of the table and isolate sound sources (e.g., other talkers or unwanted noise sources) coming from the opposite side of the table. In addition, the array microphone 100 can steer a main lobe or sound beam to any angle around the table 1002 using the beamforming techniques described herein. As a result, the array microphone 100 can be used to simultaneously generate a plurality of individual audio channels, each tailored to capture a particular talker or audio source 1004 while removing room noise, other talker noise, and other unwanted sounds. In this manner, the array microphone 100 can provide not only improved directivity but also improved signal to noise ratio (SNR) and acoustic echo cancellation (AEC) properties.

FIG. 11A is a polar plot 1100 of the vertical directivity of the array microphone 100 in FIG. 10A, in accordance with embodiments. More specifically, the polar plot 1100 depicts the frequency response of the array microphone 100 for 1900 Hz perpendicular to the table 1002 and with respect to the zero-degree azimuth of the array microphone 100, or in an unsteered (or broadside) condition. As shown, the vertical directional response of the array microphone 100 forms a cardioid polar pattern with a main lobe 1102 that is narrower than the full 360 degrees pick up patterns of the individual omni-directional microphones 102. As a result, the array microphone 100 is better able to reject unwanted sound sources at the rear of the array, for example.

FIG. 11B is a polar plot 1110 of the horizontal directivity of the array microphone 100 in FIG. 10B, in accordance with embodiments. More specifically, the polar plot 1110 depicts the frequency response of the array microphone 100 for 1900 Hz in the plane of the table 1002 and with respect to the zero-degree azimuth of the array microphone 100, or in an unsteered (or broadside) condition. As shown, the horizontal directional response of the array microphone 100 forms a uni-directional or cardioid polar pattern with a main lobe 1112 that is narrower than 180 degrees. This narrowed lobe 1112 can be directed or steered towards the individual audio sources 1004 sitting around the table 1002 with greater precision and without picking up unwanted noise or room reflections.

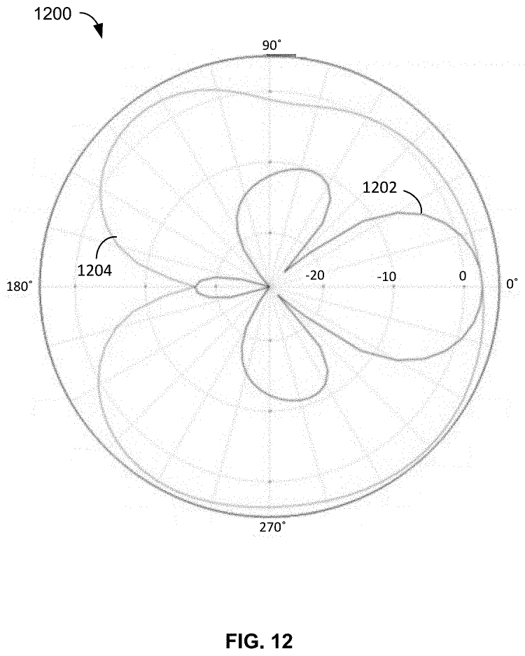

FIG. 12 is a polar plot 1200 of both horizontal and vertical directivities of the array microphone 100 in FIGS. 10A and 10B for 2500 Hz, in accordance with embodiments. Specifically, curve 1202 depicts the frequency response of the array microphone 100 for 2500 Hz in the plane of the table 1002 and in an unsteered or broadside condition (e.g., directed toward a talker positioned at zero degrees). Curve 1204 depicts the frequency response of the array microphone 100 for 2500 Hz perpendicular to the table 1002 and also in a broadside condition. As shown, the vertical directional response depicted by curve 1202 forms a cardioid polar pattern with a main lobe that is narrower than the full 360 degrees pick up patterns of the individual omni-directional microphones 102. As also shown, the horizontal directional response depicted by curve 1204 forms a uni-directional or array polar pattern with a main lobe that is narrower than 180 degrees. Typically, for harmonic sub-arrays, the higher the frequency, the greater the directivity (i.e. the narrower the beamwidth). This is demonstrated at least in FIGS. 11A, 11B, and 12 where the horizontal directional response curve 1202 for 2500 Hz has a narrower beamwidth than the horizontal directional response curve 1112 for 1900 Hz.

FIG. 13 illustrates an exemplary environment 1300 wherein the array microphone 100 is mounted, or attached, horizontally to a wall 1302, or other vertical or upright surface, in accordance with embodiments. The wall 1302 may be in a conference room or other environment having one or more audio sources (not shown) seated or situated in front of the wall 1302. For example, the audio sources (e.g., human speakers) may be seated at a table (not shown) and facing the wall 1302 for a conference call, telecast, webcast, etc. In such cases, the array microphone 100 may be placed horizontally on the wall under a television or other display screen (not shown), such that the front face 120 of the array microphone 100 is pointed down towards a bottom 1304 of the wall 1302 (or the floor) and the rear face 122 of the array microphone 100 is pointed up towards a top 1306 of the wall 1302 (or the ceiling), as shown in FIG. 13.

FIG. 14 is a plot 1400 of the directional response of the array microphone 100 shown in FIG. 13, in accordance with embodiments. More specifically, plot 1400 depicts the normalized sensitivity of the array microphone 100 for 94 dB SPL (sound pressure level) with respect to the zero-degree azimuth of the array microphone 100, or in an unsteered (or broadside) condition. As shown by segment 1402, the microphone sensitivity is significantly higher directly in front of the array microphone 100, or substantially perpendicular to the front face 120 of the array. In embodiments, segment 1402 represents a focused sound beam (or lobe) created normal to the array microphone 100, or pointing straight out from the wall 1302 towards the opposite side of the room. This sound beam may be created by combining the audio signals received from the microphones 102 in each microphone set using delay and sum formation techniques. For example, the beamformer 800 in FIG. 8 may be used to apply strict and/or optimized delay and sum beamforming techniques to create a resulting directional beam that is configured to reject unwanted noise and reflections from the ceiling and floor within the octaves covered by the microphones being summed.

As shown by segments 1404, the microphone sensitivity is significantly low at the left and right sides of the array microphone 100. In embodiments, segments 1404 may represent nulls formed at opposite sides of the array 100 due to the placement of the array microphone 100 on the wall 1302. In particular, when mounted on the wall 1302, the array microphone 100 may be able to reject or ignore sounds coming from the far left side and the far right side because the array geometry naturally creates nulls on the left and right sides and the use of a delay and sum network allows for null generation within the axis of the array 100. As shown by segments 1406 of the plot 1400, microphone sensitivity may be significantly higher in either direction within the plane of the microphones 102.

Thus, the techniques described herein provide an array microphone with a narrow, one-dimensional form factor, and improved frequency-dependent directivity in multiple dimensions, thus resulting in an improved signal-to-noise ratio (SNR) and wideband audio application (e.g., 20 hertz (Hz)≤f≤20 kilohertz (kHz)). The microphones of the array microphone are arranged in harmonically-nested orthogonal pairs configured to create a linear pattern relative to a front face of the array microphone and duplicate the linear pattern in one or more orthogonal layers for increased directivity. One or more beamformers can be used to generate a directional output for each microphone pair and to combine the directional outputs to form a cardioid polar pattern for the entire array, for example, when the array microphone is placed on a horizontal surface. When the array microphone is mounted to a vertical surface, the microphones can be combined to create a focused narrow beam directed straight ahead, or normal to the vertical surface. As a result, despite being comprised of low profile microphones (e.g., MEMS microphones), the array microphone can provide increased rear rejection and isolated forward acceptance in both wall-mounted and table-mounted orientations.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

What is claimed is:

1. An array microphone, comprising:
a plurality of microphone sets arranged in a linear pattern relative to a first axis and configured to cover a plurality of frequency bands, each microphone set comprising a first microphone arranged along the first axis and a second microphone arranged along a second axis orthogonal to the first microphone,
wherein a distance between adjacent microphones along the first axis is selected from a first group consisting of whole number multiples of a first value, and within each set, a distance between the first and second microphones along the second axis is selected from a second group consisting of whole number multiples of a second value.

2. The array microphone of claim 1, wherein the linear pattern places the plurality of microphone sets in a harmonically-nested configuration.

3. The array microphone of claim 1, wherein a number of the microphone sets are co-located on the same second axis.

4. The array microphone of claim 3, wherein the co-located microphone sets include the same first microphone but different second microphones.

5. The array microphone of claim 1, wherein the second value is determined based on a frequency value included in the plurality of frequency bands.

6. The array microphone of claim 1, wherein the first value is determined based on a linear aperture size of the array microphone.

7. The array microphone of claim 1, wherein the plurality of microphone sets are configured to form a first sub-array for covering a first octave included in the plurality of frequency bands and a second sub-array for covering a second octave included in the plurality of frequency bands.

8. The array microphone of claim 7, wherein the distance between adjacent microphones in the second sub-array along the first axis is twice the distance between adjacent microphones in the first sub-array along the first axis.

9. The array microphone of claim 7, wherein the distance between adjacent microphones in the second sub-array along the second axis is twice the distance between adjacent microphones in the first sub-array along the second axis.

10. The array microphone of claim 7, wherein the plurality of microphone sets are further configured to form a third sub-array for covering a third octave included in the plurality of frequency bands.

11. The array microphone of claim 10, wherein the distance between adjacent microphones in the third sub-array along the first axis is four times the distance between adjacent microphones in the first sub-array along the first axis.

12. The array microphone of claim 10, wherein the distance between adjacent microphones in the third sub-array along the second axis is four times the distance between adjacent microphones in the first sub-array along the second axis.

13. The array microphone of claim 1, wherein each microphone is a micro-electrical mechanical system (MEMS) microphone.

14. A method performed by one or more processors to generate an output signal for an array microphone comprising a plurality of microphones and configured to cover a plurality of frequency bands, the method comprising:
receiving audio signals from the plurality of microphones, the microphones being arranged in microphone sets configured to form a linear pattern along a first axis and extend orthogonally from the first axis;
determining a direction of arrival for the received audio signals;
selecting one of a plurality of beamforming patterns based on the direction of arrival;
combining the received audio signals in accordance with the selected beamforming pattern to generate a directional output for each microphone set; and
aggregating the outputs to generate an overall array output.

15. The method of claim 14, wherein each microphone set comprises a first microphone arranged along the first axis and a second microphone arranged on a second axis orthogonal to the first microphone, and wherein combining the received audio signals includes, for each microphone set, combining the audio signal received from the first microphone with the audio signal received from the second microphone.

16. The method of claim 15, wherein combining the audio signal received from the first microphone includes using a sum-difference beamforming technique to create the directional output.

17. The method of claim 14, wherein the microphone sets are further arranged to form a plurality of sub-arrays, each sub-array configured to cover a different octave included in the plurality of frequency bands, the method further comprising:
for each sub-array, combining the directional outputs for the microphones sets included in the sub-array to generate a sub-array output, wherein aggregating the outputs includes aggregating the sub-array outputs for the plurality of sub-arrays to generate the overall array output.

18. The method of claim 14, further comprising: applying beamforming techniques to steer the array output towards a desired direction.

19. The method of claim 14, wherein each directional output has a cardioid polar pattern.

20. The method of claim 14, wherein the plurality of beamforming patterns includes a broadside pattern and at least one oblique angle pattern.

21. The method of claim 14, wherein each microphone is a micro-electrical mechanical system (MEMS) microphone.

22. A microphone system, comprising:
an array microphone configured to cover a plurality of frequency bands, the array microphone comprising a plurality of microphones arranged in microphone sets configured to form a linear pattern along a first axis and extend orthogonally from the first axis;
a memory configured to store program code for processing audio signals captured by the plurality of microphones and generating an output signal based thereon;
at least one processor in communication with the memory and the array microphone, the at least one processor configured to execute the program code in response to receiving audio signals from the array microphone,
wherein the program code is configured to:
receive audio signals from the plurality of microphones;
determine a direction of arrival for the received audio signals;
select one of a plurality of beamforming patterns based on the direction of arrival;
combine the received audio signals in accordance with the selected beamforming pattern to generate a directional output for each microphone set; and
aggregate the outputs to generate an overall array output.

23. The microphone system of claim 22, wherein each microphone is a micro-electrical mechanical system (MEMS) microphone.

24. The microphone system of claim 22, wherein the at least one processor retrieves the selected beamforming pattern from the memory, the memory storing each beamforming pattern in association with a corresponding direction of arrival.

25. The microphone system of claim 22, wherein the program code is further configured to apply beamforming techniques to steer the array output towards a desired direction.

26. A microphone system, comprising:
an array microphone configured to cover a plurality of frequency bands and comprising a plurality of microphones arranged in a linear pattern along a first axis of the array microphone and extending orthogonally from the first axis; and
at least one beamformer configured to receive audio signals captured by the plurality of microphones and based thereon, generate an array output with a directional polar pattern that is selected based on a direction of arrival of the audio signals, the directional polar pattern being further configured to reject audio sources from one or more other directions.

27. The microphone system of claim 26, wherein the directional polar pattern includes sound beams directed normal to the first axis of the array microphone when the direction of arrival is broadside.

28. The microphone system of claim 26, wherein the directional polar pattern includes sound beams steered towards a select angle when the direction of arrival is an oblique angle relative to the first axis.

29. The microphone system of claim 28, wherein the plurality of microphones are arranged in microphone sets, each set comprising a first microphone arranged along the first axis and a second microphone arranged orthogonal to the first microphone, and the at least one beamformer steers the sound beams by applying a select amount of delay to the audio signals received from each microphone set based on a frequency band associated with said microphone set.
